(19) United States
(12) Patent Application Publication
(10) Pub. No.: US 2009/0071606 A1
(43) Pub. Date: Mar. 19, 2009

(54) Alignment system for positioning tire beads onto a tire core side wall

(76) Inventors: Richard A. Steinke, Boulder City, NV (US); Gary N. Benninger, West Bloomfield, MI (US)

Correspondence Address: M. REID RUSSELL, 854 WEST 3390 SOUTH, HURRICANE, UT, 84737, US

(21) Appl. No.: 11/901,179

(22) Filed: Sep. 17, 2007

(51) Int. Cl. B60C 15/02

(52) U.S. Cl. 156/403

(57) ABSTRACT

A combination of a plurality of equal spaced permanent magnets that are each fitted into a magnet cup formed into a cavity mold side outer surface that is immediately opposite to a slot formed around an outer edge of the inner surface of the cavity mold side, leaving a thin section of the cavity mold side material that separates the respective bottoms of the magnet cups from the bottom of the slot. The slot receives a tire bead whereover a tire plies is folded and is held in that slot by the attractive force provided by the permanent magnets, and pins are fitted at spaced intervals into, to extend outwardly from, the slot bottom surface to engage and center the tire bead in the slot.

### BACKGROUND OF INVENTION

1. Field of the Invention

This invention pertains is an apparatus and its use for positioning and maintaining tire beads, with a tire plies fitted thereto, properly positioned onto opposite sides of a tire core build mandrel in a process of building a tire core that is for fitting in a cavity mold for casting, molding or vacuum forming a urethane tire.

2. Prior Art

The present invention is in a permanent magnet arrangement for positioning each of a pair of steel tire beads onto the sides of a tire core build mandrel. Prior to which tire bead positioning, each of the pair of steel tire beads has a tire plies folded therearound, with each of the tire beads to be positioned, at an optimum location, to each of the two sides of the tire core build mandrel that can be rigid or flexible. The tire bead positioning involves a magnetic seating of each tire bead adjacent to an inner surface of a side of a cavity mold, with the sides of the cavity mold to be installed to the hub of the tire core build mandrel, the invention provides for perfectly positioning the tire beads and plies in a finished tire. After the tire core is mounted in the cavity mold a tire is cast, molded or vacuum formed that contains the tire beads that plies have been folded over.

The tire beads are formed from a magnetically attractive material so as to provide, after the tire plies have been folded thereover, for their magnetic mounting in the cavity mold, adjacent to the cavity mold sides and spaced appropriately apart from the tire core build mandrel sides. The magnets, which may be any convent shape, are fitted into magnet cups or cavities that are formed around the outer circumference of the cavity mold sides outer surfaces. Which cavity mold sides are preferably formed from aluminum, or other material, that promotes a free passage of a magnetic flux generated by each permanent magnet, with that magnetic flux passing through the cavity mold side to attract the steel tire bead. Which permanent magnets are thereby located at equal spaced radial intervals around the outer surfaces of each of the cavity mold sides such that the individual cylindrical magnet ends will be proximate to each tire bead within the cavity mold, holding the tire bead that a tire plies has been folded across, providing an optimum location to the tire bead that is spaced apart from the tire core build mandrel side, allowing for a passage of a urethane material therearound in a tire formation process.

The magnet cups or cavities are formed, at equal spaced intervals, around an outer edge of an outer surfaces of each of the pair of cavity mold sides, above a slot or channel formed in the cavity mold side inner surface. The depth of each magnet cup or cavity is such that only a narrow section of the mold cavity side material separates the end of the magnet cup or cavity and the slot or channel. So arranged, each cylindrical magnet will provide a magnetic flux that is of a strength to pass through cavity mold side to attract a steel tire bead arranged in or above the slot or channel. The magnets are of a size and manufactured from a permanent magnet material to provide the required magnetic force of attraction to attract the tire bead whereover the tire plies has been folded.

The cavity mold sides are for axially fitting to the tire core build mandrel sides at centers of tire core build mandrel hub plates. After folding and securing the tire plies over each of the tire beads, the tire beads can then be magnetically supported by the permanent magnets in the slot or channel that has been formed around the outer edges of the inner surfaces of the cavity mold sides. To maintain tire bead positioning, it is pulled by the flux generated by the permanent magnets against outer ends of straight pins that are individually fixed to extend outwardly from the slot or channel bottom surface. So arranged, each bead will be at an optimum position to the tire core build mandrel side, and will remain there during the tire core formation process. The spaced straight pins, that are arranged to extend at right or normal angles outwardly from the interior or bottom surfaces of each of the cavity mold end slots or channels, engage the tire bead when each of the tire beads is magnetically attracted by the permanent magnets, and hold the tire beads in position while the cavity mold sides are installed onto the tire core build mandrel opposite sides. The pins provide a proper stand-off distance to the tire bead to allow for a free flow of a urethane material, preferably a polyurethane material, around the tire bead in the tire casting or molding process. The pins can be steel pins that are attached at spaced intervals at equal radial distances from the center of the cavity mold side, and are pulled out of a finished tire when the tire is pulled out of the mold. Or, the pins can be formed of a material that is compatible with the urethane material, such as a pre-cure polyurethane, and are for fitting into spaced holes in the cavity mold sides to be pulled therefrom, remaining as part of the finished tire and are then trimmed to be flush with the tire inter surface after tire removal from a mold.

Similar in function to the invention, applicants recently filed a U.S. patent application for a “Bead Alignment Clip and System for its use for Locating a Tire Bead Positioning onto a Tire Core Build Mandrel in Forming a Core for Manufacturing an Elastomeric Tire”, filed Mar. 9, 2007, Ser. No. 11/715,791. This patent application sets out a clip for fitting over and holding in place a tire bead whereover a plies sleeve end has been folded, with the clips attracted to magnets fitted into the cavity mold side inner surface. While this system performs essentially the same function as that of the present invention, it is more complicated to use in that it requires exact position of the bead clips onto the plies sleeve covered tire bead, and that the clips need to be exactly positioned onto the tire bead to fit against ends of horseshoe magnets that extend at radially spaced intervals from an inner surface of a cavity mold side, to magnetically attach to and hold the plies sleeve covered tire bead exactly positioned onto the cavity mold side as it is fitted onto the hub of the tire core build mandrel. The present invention, by a utilization of larger stronger magnets and their installation in spaced cups or cavities formed in the outer surfaces of the cavity mold sides provides for magnetically attracting and holding the tire bead through a thin area of the cavity mold side, exactly positioning each tire bead in the cavity mold, adjacent to each of the sides of the tire core build mandrel. Accordingly, a practice of the invention requires greater strength of permanent magnets than the horse shoe magnets taught in the above cited application, and, of course, as the magnetic coupling of the invention is between the permanent magnet and tire bead, no bead clips are required, and there is no requirement to longitudinally line or stripe a plies sleeve for exactly mounting the bead clips onto the tire bead. Like the above cited application, however, the present invention does employ stand off pins for holding the tire bead with plies folded thereover apart from the cavity mold side bottom or inner surface and the side of the tire core build mandrel.

Prior to the present invention and the prior invention of the applicants, as set out above, in forming an elastomeric tire by molding or casting methods, the location of tire beads with ends of a tire plies folded thereover, and its placement onto sides of a tire core build mandrel has been labor intensive. A first effort at such bead mounting is shown in a U.S. Pat. No. 7,094,303 by one of the present inventors, entitled: “Method and Apparatus for Forming a Core of Plies, Belts and Beads and for Positioning the Core in a Mold for Forming an Elastomeric Tire”, Issued Aug. 22, 2006. The '303 patent shows a plies sleeve being slid over a plies sleeve expander cone and positioned across a tire build mandrel, shows tire beads as being slid over the plies sleeve ends for positioning onto the build mandrel sides, and shows the plies ends manually folded over the positioned beads. Additionally, a plies sleeve expander cone is shown utilized in another patent application of one of the inventors entitled a “Method and Apparatus for Vacuum Forming an Elastomeric Tire”, Ser. No. 10/936,635, filed Sep. 4, 2004. This U.S. patent and patent application demonstrates a first utilization of a plies sleeve that is slid over a plies sleeve expander cone and receives bead centering plates that are slid into the plies sleeve ends to capture each of a pair of beads as have traveled from the ends, along the plies sleeve outer surface. In these arrangements each tire bead with the plies sleeve end folded over it is captured and is then moved onto the side of the tire core build mandrel. This procedure is less precise than the seating of the tire bead as provided for by the invention. In both these early arrangements and in the invention, after tire bead positioning, spacing layers and belts are applied over the plies top or crown surface, completing the tire core formation process. Which tire core is then positioned in a mold cavity for casting, molding or vacuum folding a tire.

### SUMMARY OF THE INVENTION

It is a principal object of the present invention to provide a simple and efficient apparatus for positioning and maintaining each of a pair of tire beads that have received a tire plies folded thereover adjacent to sides of a tire core build mandrel in a formation of a tire core of plies, beads and belts that is for positioning in a cavity mold for forming a urethane tire.

Another object of the present invention is to provide permanent magnets to each magnetically attract a tire bead through the cavity mold sides that are formed from a non-magnetic material, such as aluminum, and which permanent magnets are selected to have a magnetic strength that is sufficient to magnetically hold the tire bead in place.

Another object is to provide appropriately shaped permanent magnets that are fitted into like shaped cups or cavities formed at spaced radial intervals around an outer surface of each of a pair of cavity mold sides, proximate to edges thereof, with the permanent magnets having a strength to magnetically attract a tire bead, that has had a plies folded thereover, through the cavity mold side for positioning the tire bead between the inner surface of the cavity mold side and the outer surface of a tire core build mandrel to receive a flow of a urethane material therearound in a tire formation process.

Another object of the present invention is to provide an off set of the tire bead, whereover the tire plies has been folded, away from the cavity mold inner or bottom surface and the tire core build mandrel outer surface, that is an arrangement of equal spaced pins that are radially mounted, at equal spaced intervals, to extend outwardly from a slot or channel that is formed into an outer edge of the cavity mold side inner surface wherein the tire bead is positioned and held in place by the permanent magnets, with the pin ends each engaging the tire bead through the plies, allowing for a free flow of the urethane material around the tire beads during tire casting, molding or vacuum forming.

Still another object of the present invention is to provide a plurality of pins where the individual pins are fixed to extend outwardly from each cavity mold side inner surface edge slot or channel such that, in a removal of the finished tire, the tire beads are pulled off from the pins, leaving small holes only.

Still another object of the present invention is to provide a plurality of pins where the individual pins are formed from a material, such as a pre-cure urethane, to be cast into the finished tire and are arranged for fitting into recesses in the cavity mold sides edge slot or channel to be removed therefrom with the finished tire and are then trimmed to be flush with the tire outer side wall surfaces.

Still another object of the present invention is to provide a plurality of equal space permanent magnets as the individual magnets that are sufficiently strong to attract the tire bead through the cavity mold side that is preferably formed from a non-magnetic material, such as aluminum, with the permanent magnets to hold that tire bead in the slot or channel formed around the outer edge of the cavity mold side inner surface, maintaining each of the tire beads in place through the thickness of the plies during tire core assembly, and during positioning of the tire core build mandrel into the cavity of the cavity mold.

The present invention is in a system of permanent magnets and their mounting into magnet cups or cavities formed at equal space intervals in outer surfaces of each of a pair of cavity mold sides that are preferably formed from a non-magnetic material, such as aluminum. The permanent magnets magnetically attract and position each of a pair of steel tire beads with a tire plies folded thereover, to position between a cavity mold side inner surface and an outer surface of a tire core build mandrel. The individual permanent magnets can be any appropriate shape and each is formed to fit into each of a plurality of equal spaced magnet cups or cavities. Each permanent magnet is formed to have a sufficient strength to magnetically attract and hold in place a steel tire bead through the cavity mold side.

The plurality of spaced permanent magnets hold the tire bead with the tire plies folded thereover in position, adjacent to the inner surface of the cavity mold side while that cavity mold side is fitted onto a hub of the tire cord build mandrel, providing for exactly positioning the tire bead adjacent to a side of the tire core build mandrel. For positioning each tire bead, the cavity mold side inner surface has a slot or channel formed around the cavity mold side inner surface, around an outer edge, that is opposite to the magnet cups or cavities. The slot or channel receives the tire bead held therein by the permanent magnets. Pins are fitted, at spaced intervals, along and to extend outwardly from the bottom surface of the slot or channel. The permanent magnets engage the tire bead, holding it away from the slot or channel bottom, to provide for spacing of the tire bead away from the slot or channel bottom, and at a desired distance from the tire core build mandrel side, allowing for a free flow of a urethane material as is passed into the cavity mold during tire formation. The pins are installed, at spaced intervals in the cavity mold sides slot or channel bottom, extending at right angles outwardly therefrom, with the pins ends to engage the tire bead through the plies folded thereover. Accordingly, when the cavity mold sides are fitted into place to the sides of the tire core build mandrel, the pins provide for centering the tire bead between which cavity mold side inner surface slot or channel and the side of the tire core build mandrel. Which positioning allows for passage of the urethane material around the tire beads in the tire molding or casting process. The combination of permanent magnets and pins greatly simplifies tire bead installation in the tire core formation process over early systems.

The invention, as shown, utilizes six (6) individual permanent magnets that are individually fitted into each of a like number cups or cavities that are formed into the outer surface of each of the pair of preferably non-magnetic cavity mold sides, at the mold side outer edges. Though, it should be understood, a greater number such as eight (8) permanent magnets and eight (8) magnet cups, or less number such as four (4) permanent magnets and four (4) magnet cups could be so used within the scope of this disclosure. The cavity mold side magnet cups or cavities are formed in the outer surface of the cavity mold side and align with the slot or channel formed around an outer edge of the cavity mold side inner surface. With the individual permanent magnets fitted in the cavity mold side magnetic cups or cavities, the magnets attract the tire bead into the slot or channel that is formed around the cavity mold side outer edge. The permanent magnets are preferably identical and, in practice, are each formed from a material such as Neodymium Iron Boron (NdFeB) and are of a size and shape to have a flux density to provide sufficient strength to attract to and position the tire bead in the cavity mold inner surface slot or channel.

In practice, the above described pins can be formed from metal, such as steel, and are fixed to extend outwardly from each cavity mold side slot or channel such that each pin aligns with approximately the center of a tire bead that is magnetically held in the slot or channel by the permanent magnets. Such steel pins remain in the cavity mold side when the finished tire is pulled therefrom, leaving small holes in the tire side walls above the ends. Alternatively, the pins can be formed from a material that is compatible with the urethane material as is used to cast the tire, preferably a polyurethane. Such pins are individually fitted into holes that are formed in the cavity mold sides slot or channel inner surface or bottom to be pulled therefrom, remaining in the tire outer side walls ends for later trimming to be flush with the tire inner side wall surface. In practice, a material that is compatible with the preferred polyurethane material is a pre-cure urethane.

### DESCRIPTION OF THE DRAWINGS

The invention may take physical form in certain parts and arrangement of parts used to mount each of a pair of tire beads that has had a tire plies, shown as but need not be within the scope of this disclosure a plies sleeve end, folded thereover between a cavity mold side inner surface and an outer surface of a tire core build mandrel side, that is shown in a preferred embodiment that will be described in detail in this specification and is illustrated in the accompanying drawings which form a part hereof:

FIG. 1 is a side elevation perspective view of a tire core build mandrel showing the mandrel as having had a tire plies, shown as a tire plies sleeve, though, it should be understood, another arrangement of tire plies could be so used within the scope of this disclosure, and which tire plies is shown folded over the tire bead, shown in broken lines, and showing a cavity mold side that has a center opening and is fitted to slide along a rod that extends outward from the center of a tire core build mandrel hub;

FIG. 2 shows a side elevation view of a tire core build mandrel of FIG. 1 that the tire core is being assembled on, and with the cavity mold side shown as having been slid into engagement with the tire core build mandrel side, capturing the tire bead whereover the tire plies has been folded;

FIG. 3 is an exploded side elevation perspective view showing the tire core build mandrel components axially fitted onto a rod that extends outwardly at a right angle from the tire core build stand, and shows the respective cavity mold sides being fitted onto the sides of the tire core build mandrel such that permanent magnets, shown herein as cylinders, are fitted into radially spaced magnet cups or cavities formed in the outer surface of each of the pair of cavity mold sides to provide a magnetic flux across the cavity mold side that is of a strength to attract a tire bead whereover the tire plies has been folded;

FIG. 4 is a front elevation view of a section of the cavity mold side and plies covered tire core build mandrel and showing a slot or channel formed around an outer edge of an inner surface of the cavity mold side wherefrom radially spaced pins are shown as extending outwardly that will align with the tire bead of FIG. 3 that has had the tire plies folded thereover, with the radially spaced pins to provide for holding the tire bead centered in the cavity mold side slot or channel so as to allow for a passage of a urethane material therearound in a casting, molding or vacuum forming operation to form a tire;

FIG. 5 is a side elevation sectional view taken along the line 5-5 of FIG. 3, showing half sections of the cavity mold sides and showing the permanent magnets aligned for installation into the magnet cups or cavities that are formed at equal radial spaced intervals into the cavity mold sides, proximate to the cavity mold side edge, with bolts shown aligned with holes for mounting the cavity mold side onto the tire core build mandrel side, and showing a section of a tire bead fitted in the slot or channel of the bottom surface of each of the cavity mold sides;

FIG. 6A is a side elevation view of a section of the tire core build mandrel fitted within a cavity mold and showing the tire bead with an end section of the tire plies folded thereover that has been magnetically held in position in the cavity mold side edge slot or channel opposite to a permanent magnet in a magnet cup or cavity formed in the cavity mold side top surface showing, one of the pins as extending outwardly from the center of the cavity mold slot or channel bottom surface that is spaced apart from the magnet cup or cavity, and which cup or cavity mold side slot or channel is shown as having received the tire bead mounting the tire plies, with the arc of which tire bead shown in broken lines and with the pin end shown as engaging the center of the tire bead, showing a cavity mold crown fitted thereover, and with that cavity shown as having been filled in a casting, molding or vacuum forming process, forming a tire that is shown as a tire section;

FIG. 6B is a view like that of FIG. 6A only showing the tire formed from a urethane material as a section that has been pulled away from cavity mold side and the tire core build mandrel hub plate;

FIG. 7 shows an enlarged end side elevation perspective view of a steel embodiment of the pin of the invention; and

FIG. 8, is a view like that of FIG. 8 only showing a polyurethane pin embodiment of the invention.

### DETAILED DESCRIPTION

The invention is in an apparatus for magnetically maintaining a tire bead that has a tire plies folded thereover in a slot or channel formed in the inner surface of each of two cavity mold sides, holding that tire bead in an optimum location during molding, for casing or vacuum forming a urethane tire. With such formed tire to have a tire bead that is at an optimum location in each tire side wall end. The invention is an improvement on an earlier U.S. patent application of the present inventors entitled “Bead Alignment Clip and System for its use for Locating a Tire Bead Positioning onto a Tire Core Build Mandrel in Forming a Core for Manufacturing an Elastomeric Tire”, filed Mar. 9, 2007, Ser. No. 11/715,791, that is cited above. The present invention improves upon this earlier invention in that it does not require a use of bead clips and magnets secured to an inner surface of each of a pair of cavity mold sides. Rather, the invention involves individual permanent magnets where each permanent magnet is fitted into a compatible magnet cup or cavity, hereinafter referred to as cup, that are formed at equal spaced radial intervals, in an outer surface of each cavity mold side. The cavity mold sides are preferably formed from a non-magnetic material, such as aluminum, and are each is coupled to a hub plate of a tire core build mandrel. The permanent magnets create a magnet field in a slot or channel, hereinafter referred to as slot, that has been formed around the cavity mold side inner edge to attract the tire bead. The permanent magnets attract the tire bead that is formed from a magnetic material such as steel, to position the tire bead with a tire plies folded thereover, into the slot, providing for an optimum alignment of the tire bead in the cavity of the cavity mold, adjacent to the tire core build mandrel side.

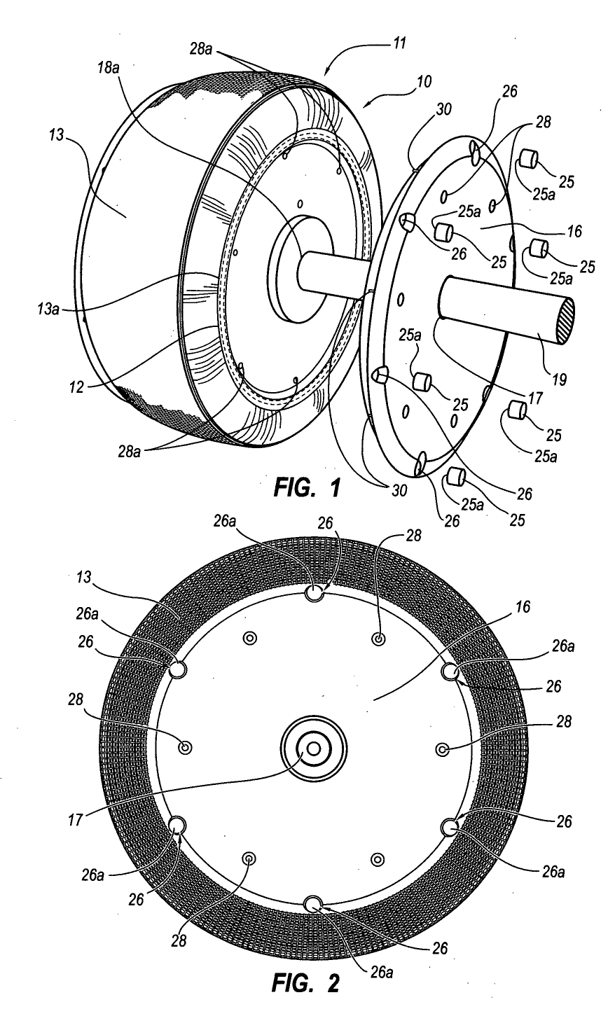

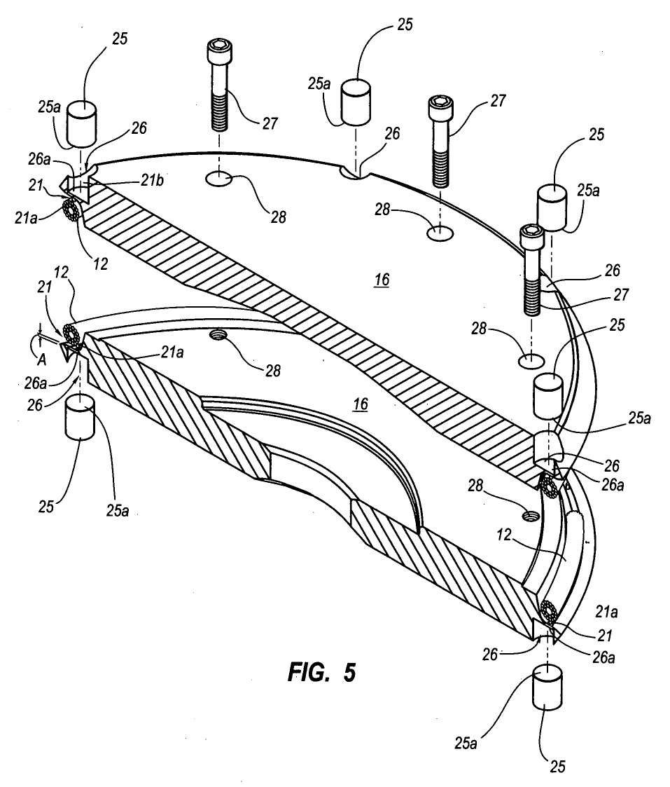

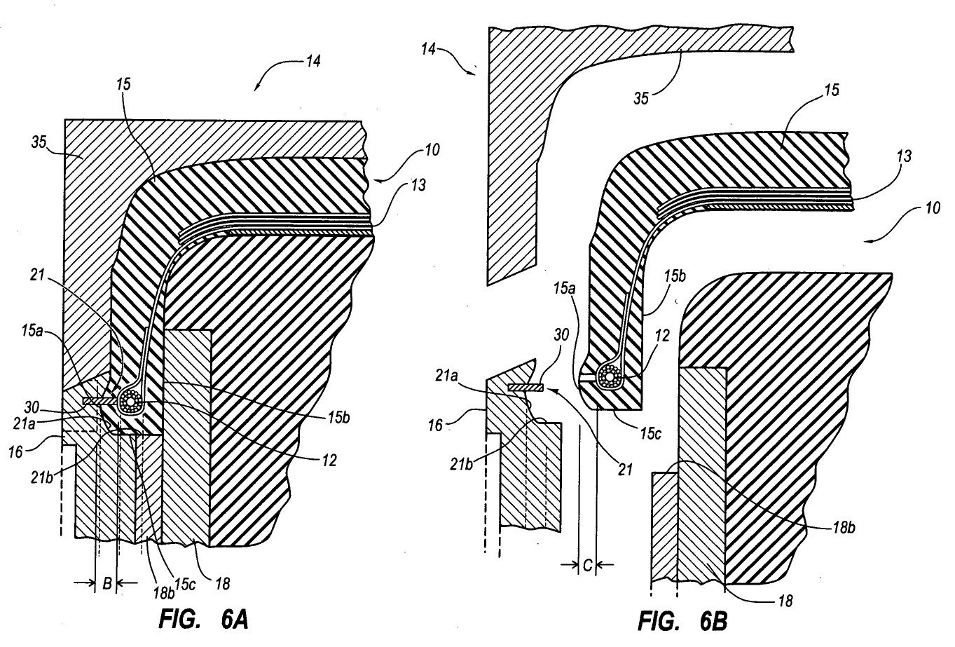

FIG. 1 shows a tire core build mandrel 10 that is for forming a tire core 11 that includes a tire bead 12, shown in broken lines, that has ends 13a, of a tire plies 13, that is shown as a sleeve, folded thereover. While a tire plies sleeve is shown, it should be understood, the tire plies 13 need not be formed as a sleeve, within the scope of this disclosure. The tire core 11 is for installation in a cavity mold 14, like that shown in FIGS. 6A and 6B, for forming a urethane tire 15. For forming such tire core, as shown in FIG. 1, with the tire core 11 arranged on the tire core build mandrel 10, cavity mold sides 16 center openings 17 are fitted onto ends of an axle 19 that extends outwardly from a center of a tire core build mandrel hub 18. The cavity mold sides that are preferably formed from a non-magnetic material, such as aluminum, have their inner surfaces 20 moved into position opposite to a tire core build mandrel 10 side 10a. In which position, the tire bead 12, that has had the tire plies 13 folded thereover, shown as tire plies sleeve end 13a, will approximately align with, to fit into a slot 21, that is formed around an outer edge of the cavity mold side inner surface 20. To hold the steel tire bead with tire plies folded thereover in position during a fitting of the cavity mold sides 16 to the sides of the tire core build mandrel 10, as shown in FIGS. 2, 3 and 4, the invention utilizes spaced permanent magnets 25, that are shown as having cylindrical shapes through, it should be understood which permanent magnets 25 can be of any convenient shape within the scope of this disclosure. The permanent magnets 25, as shown best in FIG. 5, are for fitting into magnet cups 26 that are formed at equal spaced intervals into the outer surface of each of the cavity mold sides 16, with each magnet cup 26 to have a shape that is suited to receive a permanent magnet 26 fitted therein. The magnet cups 26, shown best in FIG. 5, each terminate in flat bottoms 26a to accommodate flat ends 25a of the permanent magnets 25 positioned thereagainst. Which magnet cups flat bottoms 26a are immediately opposite to a bottom 21a of each of the slots 21, as viewed from the cavity mold inner surface 20, is formed around the outer edge of the cavity mold side inner surface 20. The respective magnet cups flat bottoms 26a and bottom 21a of each slot 21 are separated by a thickness A of the metal of the cavity mold side is formed from, as shown in FIG. 5, that, in practice is an appropriate thickness to allow a magnetic flux generated by the permanent magnet 25 to pass through the cavity mold side 16 that is preferably formed from a non-magnetic material, such as aluminum. So arranged, the permanent magnets 25 will generate a magnetic field having a strength to attract a tire bead 12 that, as shown in FIG. 5, is positioned in the mold cavity side inner surface slot 21.

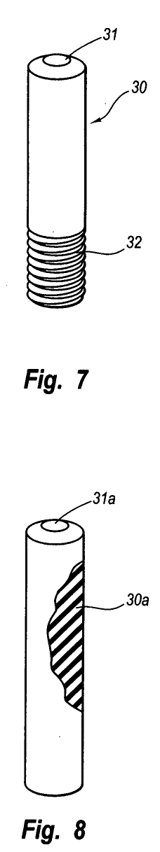

The permanent magnets 25 provide for magnetically attracting each of the tire beads 12 with the tire plies 13 folded therearound towards each of cavity mold sides 16 slots 21. Each tire bead 12, however, needs to be spaced apart from the slot 21 bottom 21a to allow for a free flow of urethane material therearound in a molding, casting or vacuum forming operation for producing the tire 15, like that shown in FIGS. 6A and 6B. Proper tire bead 12 positioning in the slot 21 is provided by straight pins 30 or 30a, like those shown in FIGS. 7 and 8, that are fitted, at spaced intervals into holes formed in the slot 21 bottom 21a, to extend outwardly, at approximately right angles from the slot or channel bottom 21a. Shown in FIG. 6A, each straight pin 30 extends a like distance B out from the slot bottom 21a to engage the tire bead 12 through the tire plies 13 folded thereover. The tire bead 12 is thereby held in place against the magnetic attraction provided by the permanent magnets 25, centering the tire bead and tire plies in the slot 21 to allow a free flow of the urethane material therearound, in a formation of the tire 15 shown in FIGS. 6A and 6B. In practice, the distance B is selected to provide essentially a same urethane material thickness from the tire bead to the inner and outer surfaces 15a and 15b, respectively, of the tire end. The pins 30 or 30a as shown in FIGS. 7 and 8, and as discussed herein below, are functionally alike and each is fitted into, to extend at a right angle outwardly from, approximately the center of the slot 21 bottom 21a, as shown in FIGS. 4, 6A and 6B, holding the tire bead centered in the slot or channel 21 against the magnetic force exerted by the magnets 25.

In practice, the tire beads 12 with the tire plies 13 folded thereover, are fitted onto the tire core, with the permanent magnets 25 providing a magnetic field that is of a strength to attract the tire bead 12 towards the bottom 21a of the slot 21, impaling the tire bead onto the either of the pins 30 or 30a ends 31 or 31a. So arranged, with the mold cavity sides 16 each fitted onto each of the tire core build mandrel 10 sides, as shown in FIG. 1 through 4, the mold cavity sides 16, as shown in FIG. 5, are each attached to a tire core build mandrel 10 side by a turning of spaced bolt 27 into holes 28 that are formed through the mold cavity sides and align with holes 28a in the tire build core mandrel hub 18, as shown in FIGS. 1, 2 and 3. The mold cavity sides 16 are thereby mounted onto the sides of the tire core build mandrel, as shown in FIG. 6A. Thereafter, with the fitting of belts, not shown, onto the top of the tire core build mandrel, above the plies 13, and a fitting of a cavity mold top or crown 35 over the tire core build mandrel 10, as shown in FIGS. 6A and 6B, the cavity mold is set to receive a flow of a urethane material, preferably a polyurethane material, forming the tire 15, by molding, casting or vacuum forming methods. After cooling, the cavity mold 14 is broken apart, as shown in FIG. 6B, and the finished tire 16 containing the tire beads 12 whereover the plies 13 have been folded located in the tire 15 ends 15b is removed. Such tire 15 can be formed by a tire casting, molding or vacuum forming process that is like that, or similar to, the arrangement set out in the earlier U.S. Pat. No. 7,094,303 of one of the inventors, cited above.

In FIG. 1 is shown a tire core build mandrel 10 and tire bead 12 that the tire plies 13 has been folded over, shown in broken lines. The tire bead 12 is formed from a magnetic material, preferably steel, and is inelastic. The tire plies 13 is fitted onto the tire core build mandrel 10 preferably utilizing a technique and structure like that set out in U.S. Pat. No. 7,094,303, as set out above. As shown in the '303 patent, the tire core build mandrel 10 is assembled from tire core segments that are fitted together into a donut shape and includes the pair of mirror image center hub plates 18 that each include center openings 18a, shown in FIG. 1. The hub plate center openings 18a receive the axle 19 fitted therethrough, as shown in FIGS. 1 through 4. The center hub plates 18, as shown in FIGS. 6A and 6B are attached to opposite sides of the tire core build mandrel and have out stepped outer edges 18b that present a flat surface with the cavity mold side ends 15c, that provides for directing a flow of urethane material therearound in the formation of the tire 15 side walls ends 15c.

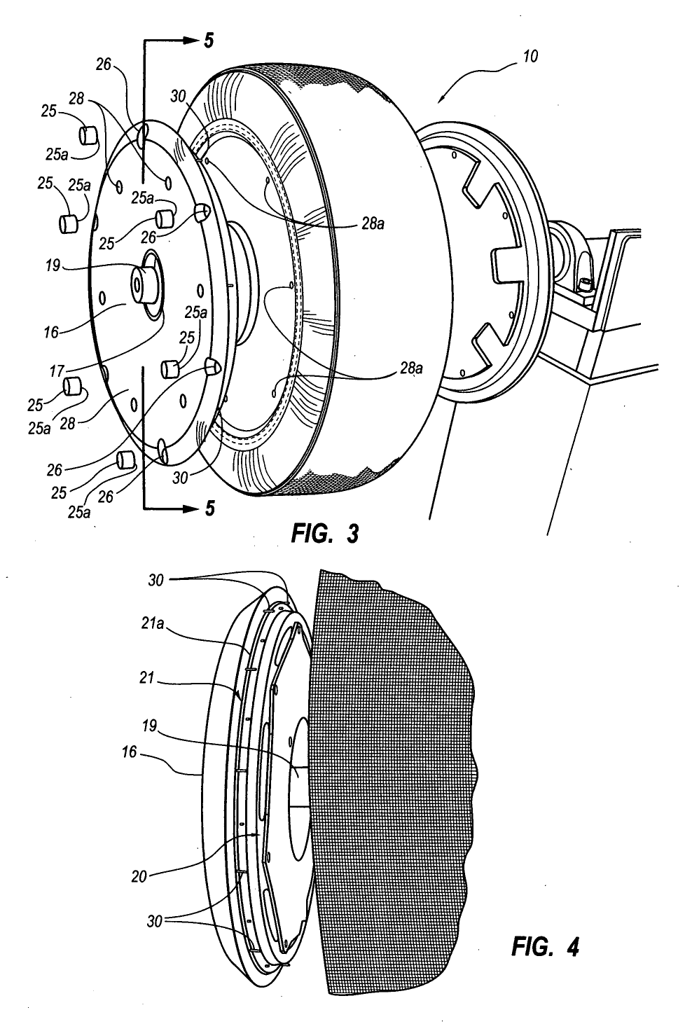

As shown in FIG. 3 and best in FIG. 5, the pair of cavity mold sides 16 are identical, each is preferably formed from a non-magnetic material such as aluminum and each is shown to include six (6) equal spaced magnet cups 26 that each receive a permanent magnet 25. Though, it should be understood a greater or lesser number of permanent magnets 25 and magnet cups 26 can be so used within the scope of this disclosure, such as eight (8) or four (4) permanent magnets and magnet cups, within the scope of this disclosure. Each magnet cup 26 provides a bottom surface 26a that is separated from the mold cavity slot 21 bottom 21a by a narrow section of cavity mold side that is shown as having a thickness A. Each of the permanent magnets 25 is sized to fit into each magnet cup 26 and provides a magnetic field that is of a strength to pass through the thin section of cavity mold side material between the cylindrical cup 26 bottom 26a and the slot 21 bottom 21a, so as to attract the steel tire bead 12 into the slot 21. Pins 30 or 30a, as shown in FIGS. 6A, 6B, 7 and 8, are fitted at equal spaced intervals along the slot 21 bottom 21a to extend at approximately right angles outwardly from the slot 21 bottom 21a, with the pins outer ends 31 or 31a to engage the steel tire bead 12 that is being magnetically pulled into the slot 21, providing for properly positioning the steel tire bead in that slot and holding it is position while the cavity mold sides 16 are being installed onto the sides of the tire core build mandrel 10, and during tire molding, casting or vacuum forming a tire 15.

In practice, a permanent magnet 25 is preferably formed from a magnet material such as a Neodymium Iron Boron (NdFeB) shaped to fit into each of the magnet cups 26 and have a sufficient strength to attract and hold the tire bead 12 with tire plies 13 folded thereover in place during the operations set out immediately above, and a permanent magnet formed from Neodymium Iron Boron (NdFeB) manufacture by Dura Magnets, Inc., of Toledo, Ohio, has been successfully used in the invention. It should, however, be understood that as few as six (6) and more than eight (8) permanent magnets, can be used within the scope of this disclosure, depending upon their individual magnetic strength, to provide for attracting the tire bead and holding it onto the pin 30 or 30a ends 31 or 31a. For the eight (8) permanent magnets 25, as shown, each is fitted into equal spaced magnet cups 26 formed around the outside edge of the outer faces of each of the mold cavity sides 16 that are opposite to the slot 21 that is formed in the cavity mold side 16 undersurface that the tire bead 12 is positioned in. The permanent magnets 25, while shown as cylinders, it should be understood, can be any appropriate shape, such as square or rectangular blocks, within the scope of this disclosure and, of course, such permanent magnet shape will require a like shape for the individual magnet cups 26. The spaced pins 30 and 30a, as shown in FIGS. 4, 6A, 6B, 7 and 8, function identically to hold the tire bead 12 off of the slot 26 inner surface bottom 26a, centering the tire bead in that slot to allow for a free flow of the urethane material, producing the tire 15, as shown in FIGS. 6A and 6B. The pin 30, shown in FIG. 7, and the pin 30a shown in FIG. 8, function identically and fitted as sets into equal spaced holes formed in the slot 21 bottom surface 21a, with each pin to extend at a right angle outwardly from, and is approximately centered in, the slot 21 bottom 21a. The pin 30, as shown in FIG. 7, has a threaded end 32 that is for turning into a thread hole formed in the slot 21 bottom 21a, and is to remain in the cavity mold side slot 21 after tire removal, as shown in FIG. 6B. Whereas, the pin 30a, as shown in FIG. 8, is not threaded and is for installation into an un-threaded hole formed into the slot 21 bottom 21a, and is pulled out of that hole, remaining in the tire 15, after removal of the tire from the mold. A utilization of the pin 30, of course, leaves a small hole in the finish tire 15 outer side wall 15a, as shown in FIG. 6B. Whereas, the pin 30a is cast into the tire 15 and can be trimmed of after tire is removed from the mold cavity. In practice, the pin 30 is preferably formed from steel to be fixed to extend outwardly from the slot 21 bottom 21a. Whereas, the pin 30a is preferably formed from a pre-cure urethane, or other appropriate material, that will combine with the urethane material, preferably a polyurethane material, as is used to form the tire 15.

While a preferred embodiment of our invention in an improved alignment system for positioning tire beads onto a tire core side wall to form a tire core for positioning in a cavity mold for casting, molding, vacuum forming or otherwise manufacturing a transport tire around the tire core has been shown and described herein, it should be understood that variations and changes are possible without departing from the subject matter coming within the scope of the following claims, and a reasonable equivalency thereof, which claims we regard as our invention.

We claim:

1. A plurality of permanent magnets in combination with like cavity mold sides for aligning tire beads to sides of a tire core build mandrel for use in forming a tire core for molding, casting or vacuum forming a urethane tire comprising, a plurality of permanent magnets that are each manufactured from a magnetic material and are identically shaped to each fit it in one of a plurality of like magnet cups that are formed at equal spaced radial intervals around an outer edge of a top of a cavity mold side that is formed from a non-magnetic material, where each said magnet cup has a same shape as that of each of the permanent magnets but is slightly larger to accommodate said permanent magnet fitted therein, and each of which said magnet cups is formed above a slot that is formed around said cavity mold side inner surface outer edge leaving a section of cavity mold side material between a bottom of said magnet cup and a bottom surface of said slot that a tire bead will fit into, and each said cavity mold side includes means for mounting it onto a side of a tire core build mandrel so as to leave a space between said cavity mold side interior surface and an exterior surface of a side of said tire core build mandrel whereon a tire core of plies, belts and beads has been formed; and straight pins means for individual fitting into equal spaced holes formed in said slot bottom surface, with each said pin outer end to engage said tire bead.

2. The plurality of permanent magnets in combination with cavity mold sides as recited in claim 1, wherein the permanent magnets each have a flat bottom surface, and the cavity mold sides spaced magnet cups have like shapes to said permanent magnets and each has a flat bottom surface that is contacted by said permanent magnet flat bottom surface.

3. The plurality of permanent magnets in combination with cavity mold sides as recited in claim 2, wherein six (6) permanent magnets are for fitting in each of six (6) magnet cups formed in each cavity mold side outer surface that are spaced equal radial distance apart.

4. The plurality of permanent magnets in combination with cavity mold sides as recited in claim 2, wherein each permanent magnet is formed from a Neodymium Iron Boron (NdFeB) material.

5. The plurality of permanent magnets in combination with cavity mold sides as recited in claim 1, wherein the cavity mold sides are formed from aluminum.

6. The plurality of permanent magnets in combination with cavity mold sides as recited in claim 1, further including a cavity mold top or crown section for connecting between the outer edges of the cavity mold sides, spanning across a top of the tire core build mandrel and spaced apart therefrom a selected distance to allow for a flow or urethane material in forming a urethane tire.

7. The plurality of permanent magnets in combination with cavity mold sides as recited in claim 1, wherein the pin means are formed from metal and are fixed to extend at right angles outwardly from the center of the cavity mold side slot bottom surface.

8. The plurality of permanent magnets in combination with cavity mold sides as recited in claim 1, wherein the pins means are formed from a pre-cure urethane that is compatible to, and will cure with, the urethane material as is used to form a tire containing the tire core, and which said pin means are for individual positioning in each of spaced holes formed into the center of the bottom surface of the slot that is formed in the cavity mold sides inner surface edge.
